(19) United States
(12) Patent Application Publication
(10) Pub. No.: US 2015/0285930 A1
(43) Pub. Date: Oct. 8, 2015

(54) SENSOR TRANSPORT

(71) Applicant: HEWLETT-PACKARD DEVELOPMENT COMPANY, L.P., Houston, TX (US)

(72) Inventor: Kevin E. Swier, Corvallis, OR (US)

(21) Appl. No.: 14/646,430

(22) PCT Filed: Nov. 26, 2012
(86) PCT No.: PCT/US2012/066523

§ 371 Date: May 21, 2015

(51) Int. Cl. G01V 1/16

(52) U.S. Cl. CPC G01V 1/168

(57) ABSTRACT

A hanger device may be used with a body harness device. The hanger device includes a main body, a stop member, and an attachment member. The main body may receive sensors. The stop member may be coupled to the main body to position the sensors on the main body. Additionally, the attachment member may be coupled to the main body. Also, the attachment member may removably attach to the body harness device in an installed state and orient the main body to direct the sensors toward the stop member in the installed state.

### BACKGROUND

Sensors such as seismic sensors may be deployed and retrieved on site in oil and gas exploration. A field worker may walk and carry the seismic sensors to various locations in a field to properly position the sensors to obtain seismic information and to retrieve the sensors when done. The field worker may transport the sensors by walking long distances to various locations in the field while directly holding the sensors and/or a crate of sensors.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a hanger device according to an example.

FIG. 2A is a side view illustrating the hanger device of FIG. 1 according to example.

FIG. 2B is a side view illustrating the hanger device of FIG. 2A with respective sensors received thereon according to an example.

FIG. 3 is a perspective view illustrating the hanger device of FIG. 2B in an uninstalled state to transfer respective sensors to a container according to an example.

FIG. 4 is a block diagram illustrating a sensor transport system according to an example.

FIGS. 5A and 5B are perspective views illustrating the sensor transport system of FIG. 4 according to examples.

FIG. 6A is a front view of a respective connector attached to a waist belt of a body harness device of the sensor transport system of FIG. 4 according to an example.

FIG. 6B is a side view of the respective connector of FIG. 6A according to an example.

FIG. 7 is a method of transporting sensors according to an example.

### DETAILED DESCRIPTION

Sensors such as seismic sensors may be used to obtain seismic information. Seismic sensors, for example, may be used as sensor nodes in a wireless seismic sensor network in oil and gas exploration. Seismic sensors may be deployed and, subsequently, retrieved in various locations in a field to obtain seismic information such as the detection of discontinuities in sound waves reflected from potential oil and/or gas reservoirs. The deployment and retrieval of sensors may require a field worker such as a juggle to transport the sensors in a field over long distances in an arduous and ergonomically uncomfortable manner. For example, the field worker may directly hold the sensors and/or a crate of sensors as an unbalanced load and/or requiring constant use of the worker's hand. Thus, at times, the field worker may have to set down the sensors and/or crate of sensors to make his or her hands available for the other actions that may require the use of two hands such as stowing the sensors, and the like. Further, while walking to various locations over many hours, the field worker may be subject to undue strain. Thus, the effectiveness, speed, and comfort in transporting the sensors for deployment and retrieval in the field by the field worker may be reduced.

In examples, a hanger device may be used with a body harness device. The hanger device may include a main body, a stop member, and an attachment member. The main body may receive sensors. The stop member may be coupled to the main body to position the sensors on the main body. The attachment member may be coupled to the main body. Further, the attachment member may removably attach to the body harness device in an installed state and to orient the main body to direct the sensors toward the stop member in the installed state. The installed state is a state in which the hanger device is attached to the body harness device in a manner to orient the main body to direct the sensors toward the stop member. An uninstalled state is a state in which the hanger device is not attached to the body harness device. A user may place the body harness device on his or her body and place the hanger device to receive sensors in an installed state on the body harness device. Thus, a field worker may transport the sensors received on the hanger device over long distances in a more balanced manner without requiring constant use of his or her hands and without undue strain. Also, the field worker may transport the sensors while having two hands free to perform other actions such as stowing the sensors, and the like. Accordingly, the effectiveness, speed, and comfort in transporting the sensors for deployment and retrieval in the field may be increased.

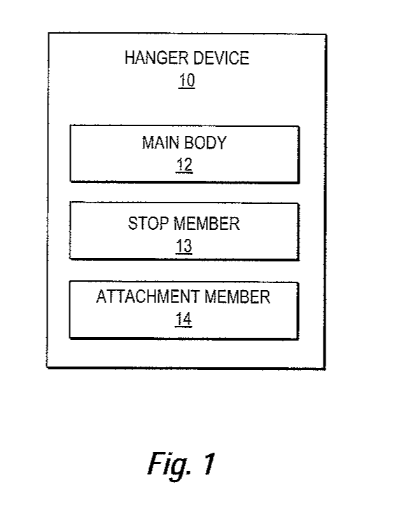

FIG. 1 is a block diagram illustrating a hanger device according to an example. The hanger device may be usable with a body harness device. Referring to FIG. 1, in some examples, a hanger device 10 may include a main body 12, a stop member 13, and an attachment member 14. The main body 12 may receive sensors. The stop member 13 may be coupled to the main body 12 to position the sensors on the main body 12. Additionally, the attachment member 14 may be coupled to the main body 12. The attachment member 14 may also removably attach to the body harness device in an installed state and orient the main body 12 to direct the sensors toward the stop member 13 in the installed state. In some examples, the main body 12 and the attachment member 14, and/or portions thereof, may be coupled to each other by being formed of a single, unitary member such as an elongated rod. Alternatively, in some examples, the main body 12 and the attachment member 14, and/or portions thereof, may be coupled to each other by attaching previously separate members to each other.

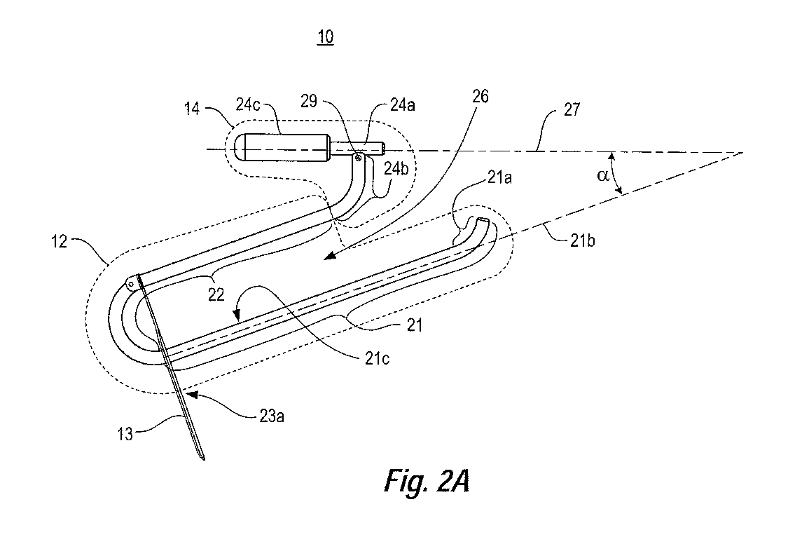

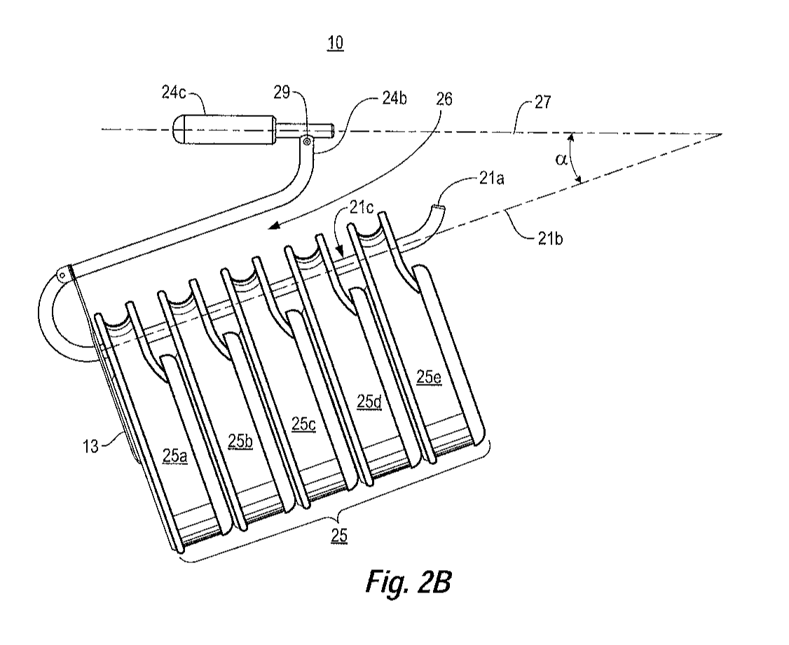

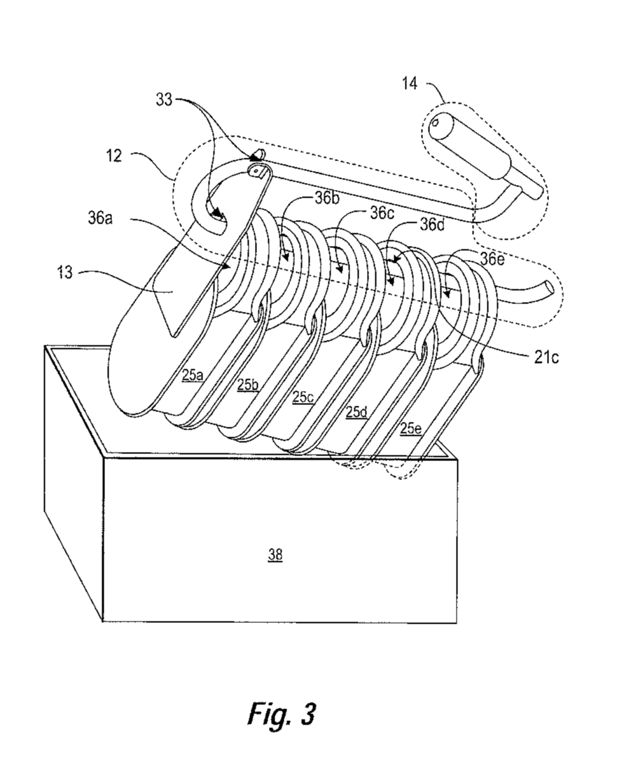

FIG. 2A is a side view illustrating the hanger device of FIG. 1 according to an example. FIG. 2B is a side view illustrating the hanger device of FIG. 1 with respective sensors received thereon according to an example. FIG. 3 is a perspective view illustrating the hanger device of FIG. 2B in an uninstalled state to transfer respective sensors to a container according to an example. Referring to FIGS. 2A and 2B, in some examples, a hanger device 10 may include the main body 12, the stop member 13, and the attachment member 14 as previously disclosed with respect to FIG. 1. The main body 12 may receive sensors 25a, 25b, 25c, 25d, and 25e (collectively 25) as illustrated in FIG. 2B. In some examples, the sensors 25 may be seismic sensors used as sensor nodes in a wireless seismic sensor network in oil and gas exploration. The sensors 25 may include antennas and cables (not illustrated).

Referring to FIGS. 2A and 2B, in some examples, the main body 12 may also include a sensor receiving portion 21 and an intermediate portion 22. The sensor receiving portion 21 may extend through openings 36a, 36b, 36c, 36d, and 36e (collectively 36) (FIG. 3) of the sensors 25 to receive the sensors 25. The sensor receiving portion 21 may also include an end receiving portion 21a, a first longitudinal axis 21b, and a declining slope 21c. The end receiving portion 21a may be the initial part of the sensor receiving portion 21 to extend through openings 36 (FIG. 3) of the sensors 25. In some examples, the end receiving portion 21a may be curved and the first longitudinal axis 21b may extend through a substantial portion of the sensor receiving portion 21. The declining slope 21c may decline from the end receiving portion 21a toward the stop member 13 in the installed state. Thus, the declining slope 21c may direct the sensors 25 received by the sensor receiving portion 21 toward the stop member 13 in the installed state. For example, force from the weight of the respective sensors 25 may cause the sensors 25 to slide down the declining slope 21c of the sensor receiving portion 21.

Referring to FIGS. 2A and 2B, in some examples, the intermediate portion 22 may be coupled to the sensor receiving portion 21 and the attachment member 14. In some examples, the sensor receiving portion 21 and the intermediate portion 22 may be in a form of an elongated rod portion. For example, the sensor receiving portion 21 and the intermediate portion 22 may be formed from a single, unitary rod. The intermediate portion 22 and the sensor receiving portion 21 may form a sensor clearance region 26 for the sensors 25 to be received by the main body 12. That is, the sensor clearance region 26 may provide clearance for a portion of the respective sensors 25 to be directed along the sensor receiving portion 21.

Referring to FIGS. 2A and 2B, in some examples, the stop member 13 may be coupled to the main body 12 to position the sensors 25 on the main body 12. For example, the stop member 13 may be coupled to the intermediate portion 22 and the sensor receiving portion 21. The stop member 13 may position the sensors 25 by contacting and/or stopping an initially-received sensor 25a at a respective position on the sensor receiving portion 21 and, subsequently, having the initially-received sensor 25a contact and/or stop a subsequently-received sensor 25b at a respective position on the sensor receiving portion 21. Thus, the sensors 25 may be positioned on the hanger device 10 in a stacking-type arrangement in which a subsequently-received sensor 25b may be contacted and/or positioned by an adjacent, previously-received sensor 25a. This stacking-type arrangement may include a plurality of sensors 25 such as five sensors 25a, 25b, 25c, 25d, and 25e. In some examples, the stop member 13 may include a substantially planar surface 23a and a plurality of openings 33 (FIG. 3) to receive each one of the sensor receiving portion 21 and the intermediate portion 22, respectively. In some examples, the stop member 13 may be substantially perpendicular with the sensor receiving portion 21 and the intermediate portion 22.

Referring to FIGS. 2A and 2B, in some examples, the attachment member 14 may be coupled to the main body 12. The attachment member 14 may removably attach to the body harness device in an installed state and orient the main body 12 to direct the sensors 25 toward the stop member 13 in the installed state. For example, in the installed state, the main body 12 may include a sensor receiving portion 21 having a declining slope 21c to decline from an end receiving portion 21a thereof toward the stop member 13 to direct the sensors 25 received by the sensor receiving portion 21 toward the stop member 13. In some examples, the attachment member 14 may include a first attachment portion 24a, a second attachment portion 24b, and a handle 24c.

In some examples, the first attachment portion 24a may include a second longitudinal axis extending 27 there through. In some examples, the second longitudinal axis 27 of the first attachment portion 24a and the first longitudinal axis 21b of the sensor receiving portion 21 may form an angle α there between. In some examples, the angle a may be in a range of five degrees to forty-five degrees. The second attachment portion 24b may be disposed between and coupled to the sensor receiving portion 21 and the first attachment portion 24a. The attachment member 14 may include a fastener 29 such as a screw, pin, rivet, and the like. In some examples, the fastener 29 may connect the first attachment portion 24a to the second attachment portion 24b. The second attachment portion 24b and the first attachment portion 24a may form an angle there between. In some examples, the second attachment portion 24b may be curved to orient the sensor receiving portion 21 to direct the sensors 25 toward the stop member 13 in the installed state.

The handle 24c may be coupled to the first attachment portion 24a and held by the user in the uninstalled state to place the hanger device 10 in the installed state and the uninstalled state. The handle 24c may also be held by the user in the uninstalled state to transport the sensors 25 received by the hanger device 10 to various locations. For example, the user may hold the handle 24c of the hanger device 10 in the uninstalled state to transport the sensors 25 on the hanger device 10 to a container 38 to, subsequently, transfer the sensors 25 from the hanger device 10 to the container 38 for storage, shipping, and the like. In some examples, in the uninstalled state, the hanger device 10 may be oriented by the user to enable the declining slope 21c of the sensor receiving portion 21 to descend from the stop member 13 toward the sensor receiving portion 21 to direct the sensors 25 from the hanger device 10 and to the container 38 as illustrated in FIG. 3. Thus, the sensors 25 may be transferred from the hanger device 10 and into the container 38 as a group. Alternatively, the sensors 25 may be transferred from the container 38 and onto the hanger device 10 as a group, for example, to be transported to and deployed in the field.

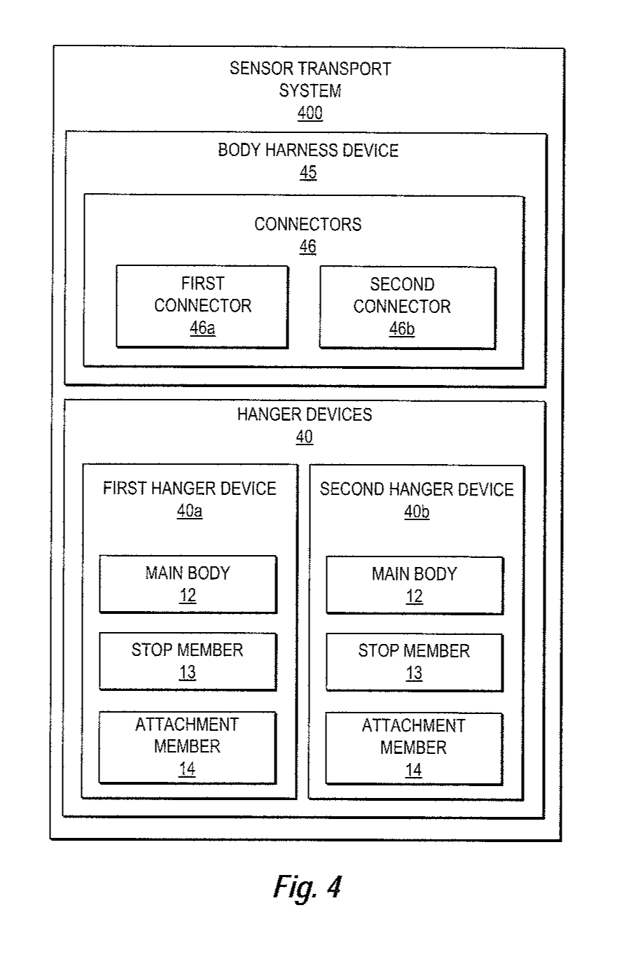

FIG. 4 is a block diagram illustrating a sensor transport system according to an example. Referring to FIG. 4, in some examples, a sensor transport system 400 may include a body harness device 45 and a plurality of hanger devices 40. The body harness device 45 may include a plurality of connectors 46 and receive a user. For example, the connectors 46 may include a first connector 46a and a second connector 46b. Each one of the hanger devices 40 may include the main body 12, the stop member 13, and the attachment member 14 as previously disclosed with respect to the hanger device 10 of FIGS. 1-3. For example, the plurality of hanger devices 40 may include a first hanger device 40a and a second hanger device 40b. The main body 12 may receive a plurality of sensors. The stop member 13 may be coupled to the main body 12 to position the sensors on the main body 12. The attachment member 14 may be coupled to the main body 12 to removably attach to the respective connector 46a and 46b in an installed state. The attachment member 14 may also orient the main body 12 to direct the sensors toward the stop member 13 in the installed state.

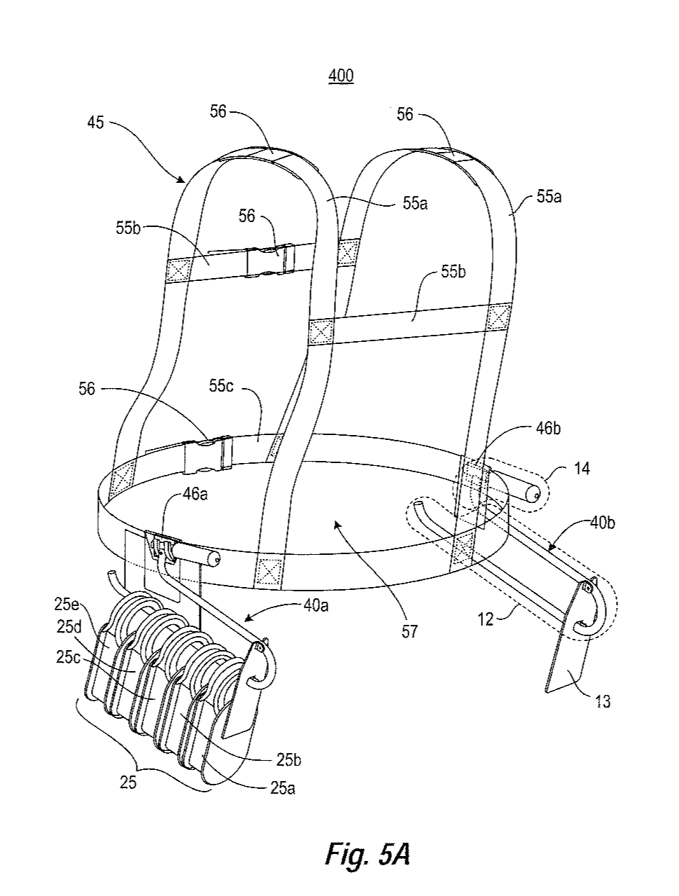

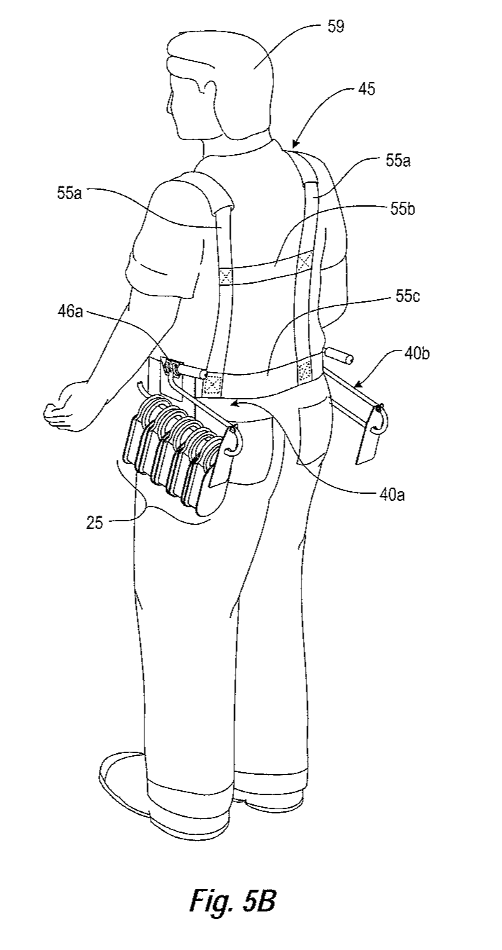

FIGS. 5A and 5B are perspective views illustrating the sensor transport system of FIG. 4 according to examples. FIG. 5B illustrates the sensor transport system of FIG. 5A placed on a user. Referring to FIGS. 4-5B, in some examples, the sensor transport system 400 may include a plurality of hanger devices 40 and a body harness device 45 as previously disclosed with respect to FIG. 4. Each one of the hanger devices 40 may include the main body 12, the stop member 13, and the attachment member 14 as previously disclosed with respect to the hanger device 10 of FIGS. 1-3. The hanger devices 40 may include a first hanger device 40a and a second hanger device 40b. The first hanger device 40a may be placed on the body harness device 45 to be positioned by one side of a user 59 and the second hanger device 40b may be placed on the body harness device 45 to be positioned by another side of a user 59. In some examples, each one of the hanger devices 40 placed on opposite sides of a user 59 may distribute the weight of the sensors 25 disposed thereon and enable a more balanced load.

Referring to FIGS. 4-5B, in some examples, the body harness device 45 may include a plurality of connectors 46, a plurality of straps 55a, 55b, and 55c (collectively 55), and a plurality of strap adjustment members 56. The plurality of straps 55 may be coupled to each other to form a body region 57 to receive the user 59. For example, a user 59 may place his or her body into the body region 57 of the body harness device 45. The straps 55 may include shoulder straps 55a, intermediate straps 55b, and a waist belt 55c to surround the user. The shoulder straps 55a may be placed over the shoulders of a user 59. The intermediate straps 55b may connect to and extend between the shoulder straps 55a. The waist belt 55c may be connected to the shoulder straps 55a and be placed around the waist of the user 59.

The strap adjustment members 56 may adjust a length of the respective straps 55. For example, the straps 55 may be adjusted to conform to the user 59 and/or distribute the load carried by the sensor transport system 400 with respect to the user 59. The connectors 46 may receive the hanger devices 40 to receive the sensors 25, respectively. For example, a first connector 46a may removably receive a first hanger device 40a and a second connector 46b may removably receive a second hanger device 40b. In some examples, the connectors 46 may be permanently fixed to the body harness device 45 such as to the waist belt 55c. Alternatively, in some examples, the connectors 46 may be removably attached the body harness device 45 such as to the waist belt 55c.

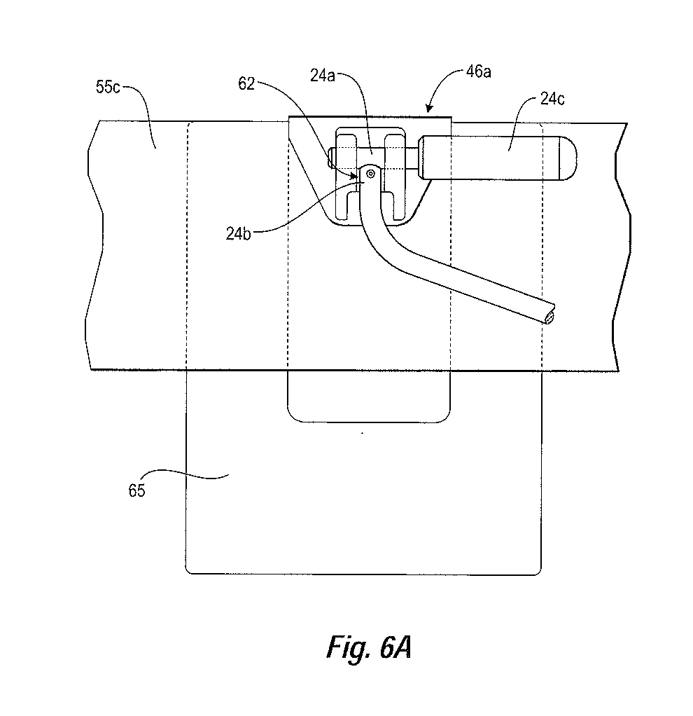

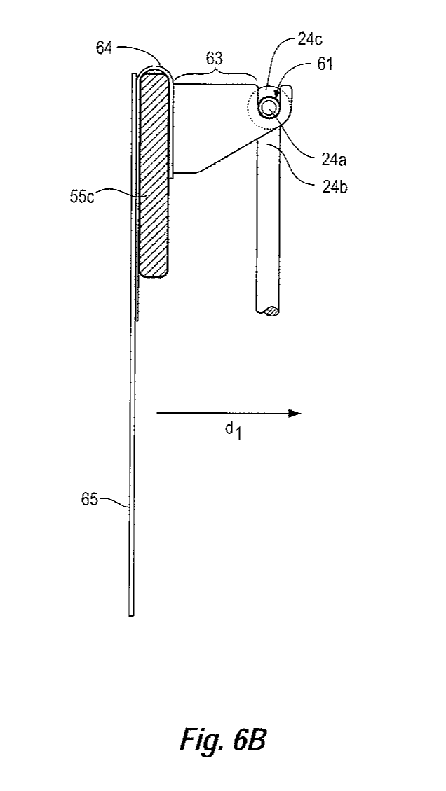

FIG. 6A is a front view of a respective connector attached to a waist belt of a body harness device of the sensor transport system of FIG. 4 according to an example. FIG. 6B is a side view of the respective connector of FIG. 6A according to an example. Referring to FIGS. 6A and 6B, in some examples, the first connector 46a and/or the second connector 46b (FIG. 5A) may include a first receiving portion 61, a second receiving portion 62, an extension portion 63, a coupling portion 64, and a shield portion 65. The first receiving portion 61 may receive the first attachment portion 24a of the attachment member. For example, the first receiving portion 61 may have a first recessed surface for the first attachment portion 24a to rest against in the installed state. The second receiving portion 62 may receive the second attachment portion 24b of the attachment member. For example, the second receiving portion 62 may have a second recessed area for the second attachment portion 24b to be disposed in the installed state. A handle 24c may be coupled to the first attachment portion 24a.

Referring to FIGS. 6A and 6B, in some examples, the extension portion 63 may extend the first receiving portion 61 and the second receiving portion 62 outward (e.g., in an outward direction d₁) from the body harness device 45 (FIGS. 5A and 5B) such as the waist belt 55c. For example, the extension portion 63 may extend outward a position of the first and second receiving portions 61 and 62 away from the waist belt 55c to provide a clearance distance between the hanger device and a portion of the user in the installed state. That is, the extension portion 63 may provide space between a user's hip and/or leg portion and the sensors disposed on the respective hanger device. The coupling portion 64 may couple the respective connector 46a and 46b to the body harness device 45.

In some examples, the respective connector 46a and 46b may be permanently coupled to body harness device 45. Alternatively, in some examples, the respective connector 46a and 46b may be removably coupled to the body harness device 45 such as to the waist belt 55c thereof. The shield portion 65 may shield a portion of the user from contact with the sensors received by the hanger device in the installed state. For example, the shield portion 65 may extend between a hip and/or leg portion of the user and the sensors disposed on the hanger device. Thus, the hip and/or leg portion of the user may not directly contact the sensors disposed on the hanger device during the transportation thereof. In some examples, the shield portion 65 may include a pad member.

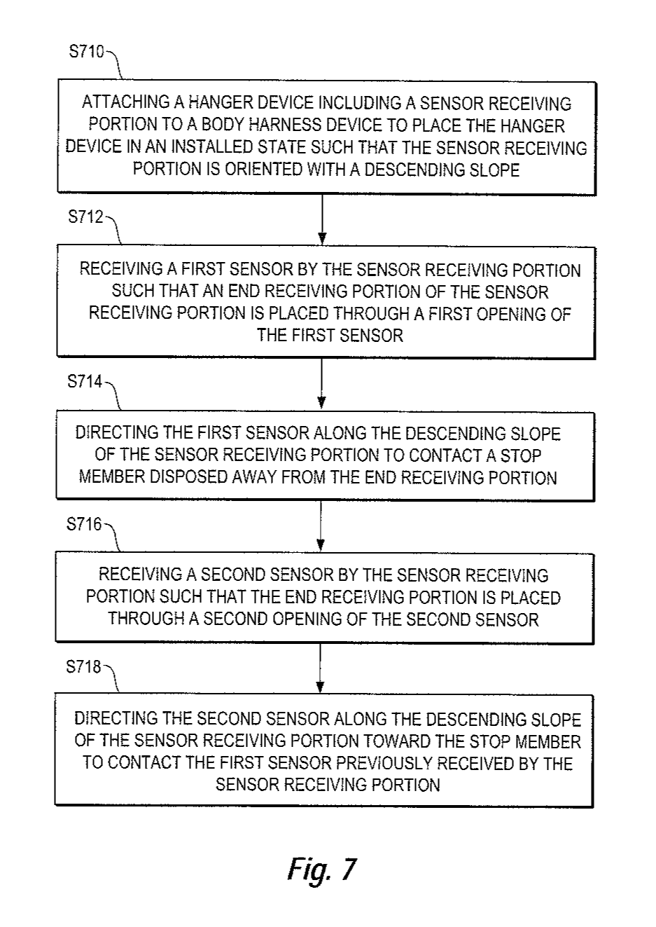

FIG. 7 is a flowchart illustrating a method of transporting sensors according to an example. Referring to FIG. 7, in block S710, a hanger device including a sensor receiving portion is attached to a body harness device to place the hanger device in an installed state such that the sensor receiving portion is oriented with a descending slope. For example, the descending slope may descend from an end receiving portion of the sensor receiving portion toward a stop member of the hanger device in the installed state.

In block S712, a first sensor is received by the sensor receiving portion such that an end receiving portion of the sensor receiving portion is placed through a first opening of the first sensor. In block S714, the first sensor is directed along the descending slope of the sensor receiving portion to contact a stop member disposed away from the end receiving portion. In block S716, a second sensor is received by the sensor receiving portion such that the end receiving portion is placed through a second opening of the second sensor. In block S718, the second sensor is directed along the descending slope of the sensor receiving portion toward the stop member to contact the first sensor previously received by the sensor receiving portion.

In some examples, the method may also include removing the hanger device including the first sensor and the second sensor received by the sensor receiving portion from the body harness device to place the hanger device in an uninstalled state. Additionally, the method may also include transferring the first sensor and the second sensor from the sensor receiving portion of the hanger device to a container. For example, the sensor receiving portion may be positioned such that the descending slope descends from the stop member toward the end receiving portion in the uninstalled state. Thus, the declining slope may direct the sensors disposed on the sensor receiving portion therefrom and into the container. In some examples, the first sensor and the second sensor may be simultaneously moved along the descending slope of the sensor receiving portion to the container.

It is to be understood that the flowchart of FIG. 7 illustrates architecture, functionality, and/or operation of examples of the present disclosure. Although the flowchart of FIG. 7 illustrates a specific order of execution, the order of execution may differ from that which is depicted. For example, the order of execution of two or more blocks may be scrambled relative to the order illustrated. Also, two or more blocks illustrated in succession in FIG. 7 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A hanger device usable with a body harness device, the hanger device comprising:
a main body to receive sensors;
a stop member coupled to the main body to position the sensors on the main body; and
an attachment member coupled to the main body, the attachment member to removably attach to the body harness device in an installed state and to orient the main body to direct the sensors toward the stop member in the installed state.

2. The hanger device according to claim 1, wherein the main body further comprises:
a sensor receiving portion including an elongated rod portion to extend through openings of the sensors to receive the sensors; and
an intermediate portion including an elongated rod portion coupled to the sensor receiving portion and the attachment member, the intermediate portion and the sensor receiving portion to form a sensor clearance region for the sensors to be received by the main body.

3. The hanger device according to claim 2, wherein the attachment member comprises:
a first attachment portion; and
a second attachment portion disposed between and coupled to the sensor receiving portion and the first attachment portion, the second attachment portion and the first attachment portion to form an angle there between; and
wherein the second attachment portion is curved to orient the sensor receiving portion to direct the sensors toward the stop member in the installed state.

4. The hanger device according to claim 3, wherein the attachment member further comprises:
a handle coupled to the first attachment portion.

5. The hanger device according to claim 2, wherein the sensor receiving portion further comprises:
an end receiving portion; and
a declining slope to decline from the end receiving portion toward the stop member in the installed state.

6. The hanger device according to claim 2, wherein the stop member comprises:
a substantially planar surface, the stop member is coupled to the intermediate portion and the sensor receiving portion to contact a respective sensor received by the sensor receiving portion.

7. A sensor transport system, comprising:
a body harness device to receive a user, the body harness device including a plurality of connectors; and
a plurality of hanger devices, each one including a main body, a stop member, and an attachment member;
the main body to receive a plurality of sensors;
the stop member coupled to the main body to position the sensors on the main body; and
the attachment member coupled to the main body to removably attach to the respective connector in an installed state, the attachment member to orient the main body to direct the sensors toward the stop member in the installed state.

8. The sensor transport system according to claim 7, wherein the main body further comprises:
a sensor receiving portion including an elongated rod portion to extend through openings of the sensors to receive the sensors; and
an intermediate portion including an elongated rod portion coupled to the sensor receiving portion and the attachment member, the intermediate portion and the sensor receiving portion to form a sensor clearance region for the sensors to be received by the main body.

9. The sensor transport system according to claim 8, wherein the attachment member comprises:
a first attachment portion; and
a second attachment portion disposed between and coupled to the sensor receiving portion and the first attachment portion, the first attachment portion and the second attachment portion to form an angle there between.

10. The sensor transport system according to claim 9, wherein each one of the plurality of connectors comprises:
a first receiving portion to receive the first attachment portion of the attachment member;
a second receiving portion to receive the second attachment portion of the attachment member;
an extension portion to extend the first receiving portion and the second receiving portion outward from the body harness device;
a coupling portion to couple the respective connector to the body harness device; and
a shield portion to shield a portion of the user from contact with the sensors received by the respective hanger device.

11. The sensor transport system according to claim 7, wherein the body harness device further comprises:
a plurality of straps coupled to each other to form a body region to receive the user; and
a strap adjustment member to adjust a length of a respective strap to conform to the user.

12. A method of transporting sensors, comprising:
attaching a hanger device including a sensor receiving portion to a body harness device to place the hanger device in an installed state such that the sensor receiving portion is oriented with a descending slope;
receiving a first sensor by the sensor receiving portion such that an end receiving portion of the sensor receiving portion is placed through a first opening of the first sensor;
directing the first sensor along the descending slope of the sensor receiving portion to contact a stop member disposed away from the end receiving portion;
receiving a second sensor by the sensor receiving portion such that the end receiving portion is placed through a second opening of the second sensor; and
directing the second sensor along the descending slope of the sensor receiving portion toward the stop member to contact the first sensor previously received by the sensor receiving portion.

13. The method according to claim 12, wherein the descending slope descends from the end receiving portion toward the stop member in the installed state.

14. The method according to claim 12, further comprising:
removing the hanger device including the first sensor and the second sensor received by the sensor receiving portion from the body harness device to place the hanger device in an uninstalled state; and
transferring the first sensor and the second sensor from the sensor receiving portion of the hanger device to a container.

15. The method according to claim 14, wherein the transferring the first sensor and the second sensor from the sensor receiving portion of the hanger device to a container further comprises:
positioning the sensor receiving portion such that the descending slope descends from the stop member toward the end receiving portion in the uninstalled state; and
simultaneously moving the first sensor and the second sensor along the descending slope of the sensor receiving portion to the container.
